(19) United States
(12) Patent Application Publication
(10) Pub. No.: US 2025/0315002 A1
(43) Pub. Date: Oct. 9, 2025

(54) IMAGE FORMING APPARATUS FOR FORMING TONER IMAGE FOR ADHERING FOIL ONTO SHEET

(71) Applicant: CANON KABUSHIKI KAISHA, Tokyo (JP)

(72) Inventors: Shuichi Tamura, Ibaraki (JP); Kota Kurokawa, Chiba (JP); Kenichiro Kitajima, Ibaraki (JP); Shingo Hirota, Ibaraki (JP); Shuhei Yasuda, Chiba (JP); Ryohei Terada, Chiba (JP); Tohru Nakaegawa, Chiba (JP); Daisuke Katayama, Chiba (JP)

(21) Appl. No.: 19/093,580

(22) Filed: Mar. 28, 2025

(30) Foreign Application Priority Data
Apr. 3, 2024 (JP) 2024-060398

(51) Int. Cl. G03G 15/00

(52) U.S. Cl. CPC G03G 15/6585; G03G 15/5016; G03G 15/6544; G03G 2215/00827; G03G 2215/00835; G03G 2215/00877; G03G 2215/00936

(57) ABSTRACT

An image forming apparatus accepts a selection of a first mode for forming a toner image for adhering foil onto a sheet via the toner image and an input of information relating to post-processing. The apparatus forms the toner image on the sheet. The apparatus displays a warning on a display according to the information relating to the post-processing, when the first mode is selected by the input unit.

### BACKGROUND OF THE INVENTION

### Field of the Invention

The present invention relates to an image forming apparatus for forming a toner image for adhering foil onto a sheet.

### Description of the Related Art

Foil printing technology is used in the fields of bookbinding, commercial printing, card business, and plastic molding for cosmetic containers, among others. Characters or designs made of foil can achieve a metallic feel that is difficult to express with printing and provide a glossy finish. Foil printing is also used for holograms of credit cards and the like. According to Japanese Patent Laid-Open No. 2017-156723 and Japanese Patent Laid-Open No. 2021-116185, there has been proposed a foil printer in which a toner image is formed on a sheet in advance, and foil is transferred onto the sheet by using the toner image as an adhesive.

However, in a case where the foil is adhered onto the sheet via the toner, there is a possibility that a defect may occur in the foil forming depending on post-processing (e.g. stapling, bookbinding, or folding) applied to the sheet.

### SUMMARY OF THE INVENTION

The present disclosure provides an image forming apparatus comprising: an input unit configured to accept a selection of a first mode for forming a toner image for adhering foil onto a sheet via the toner image and an input of information relating to post-processing; an image forming unit configured to form the toner image on the sheet; and a display unit configured to display a warning according to the information relating to the post-processing, when the first mode is selected by the input unit.

Further features of the present invention will become apparent from the following description of exemplary embodiments with reference to the attached drawings.

### BRIEF DESCRIPTION OF THE DRAWINGS

FIG. 1 is a diagram explaining an image forming system.

FIGS. 2A and 2B are diagrams explaining foil processing.

FIG. 3 is a diagram explaining a post-processing apparatus.

FIG. 4 is a diagram explaining a controller.

FIG. 5 is a flowchart showing a control method.

FIG. 6 is a diagram explaining a controller.

FIG. 7 is a flowchart showing a control method.

FIG. 8 is a diagram explaining a controller.

FIG. 9 is a flowchart showing a control method.

FIGS. 10A and 10B are diagrams explaining a user interface.

FIG. 11 a diagram explaining a controller.

FIG. 12 is a flowchart showing a control method.

FIG. 13 a diagram explaining a user interface.

FIG. 14 a diagram explaining a user interface.

### DESCRIPTION OF THE EMBODIMENTS

Hereinafter, embodiments will be described in detail with reference to the accompanying drawings. Note that the following embodiments do not limit the invention according to the claims. Although a plurality of features are described in the embodiment, not all of the plurality of features are essential to the invention, and a plurality of features may be arbitrarily combined. Further, in the accompanying drawings, the same or similar components are denoted by the same reference numerals, and redundant description will be omitted.

### I. First Embodiment

### 1. Image Forming System (Foil Printing System)

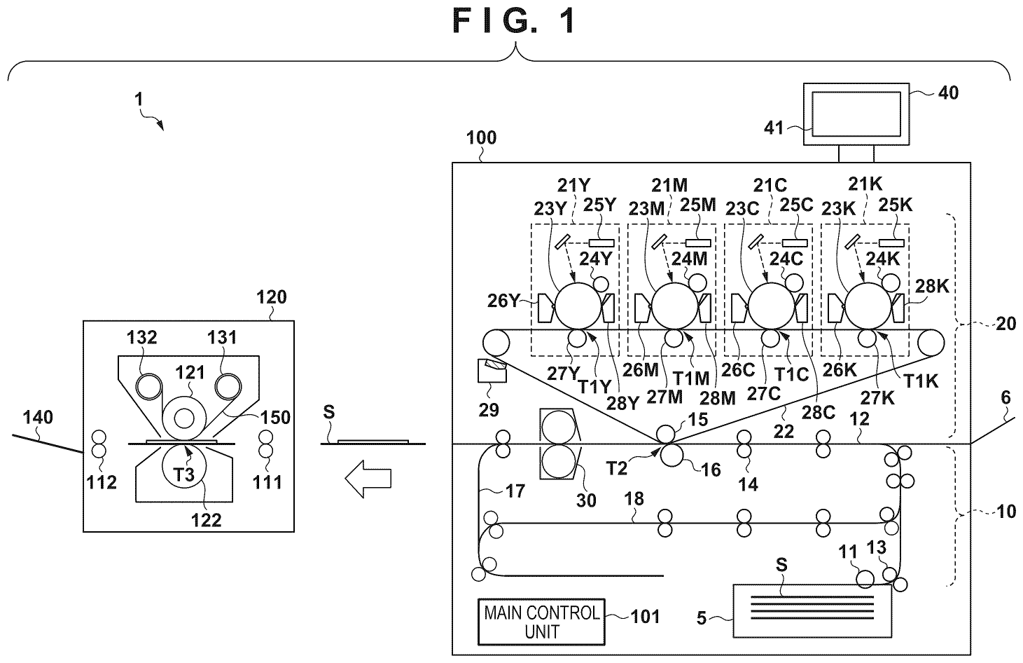

As shown in FIG. 1, an image forming system 1 includes an image forming apparatus 100 and a foil printer 120. The image forming apparatus 100 forms a toner image on a sheet (also referred to as a recording material) S. The foil printer 120 prints foil on the sheet S using a toner of the toner image as a glue.

The image forming system 1 is a so-called offline type system in which the foil printer 120 is not mechanically coupled to the image forming apparatus 100. In this case, the sheet S on which the toner image is formed is discharged from the image forming apparatus 100 and then manually inserted to the foil printer 120 by a user (see an arrow in the drawing). In other embodiments, an inline type system may be provided in which the foil printer 120 is coupled to the image forming apparatus 100. In this case, the sheet S is automatically transferred from the image forming apparatus 100 to the foil printer 120. In yet another embodiment, an integrated printing apparatus may be provided that incorporates the foil printing capability of the foil printer 120 into the interior of the image forming apparatus 100.

### 1-1. Image Forming Apparatus

The image forming apparatus 100 may be a color printer or a monochrome printer. In the example of FIG. 1, the image forming apparatus 100 is a tandem type full color printer capable of forming full color images with an electrophotographic manner. The image forming apparatus 100 includes a cassette 5, a manual feed tray 6, a conveyance unit 10, an image forming unit 20, a fixing unit 30, an operation unit 40, and a main control unit 101.

The image forming unit 20 is an image forming unit including a process units 21Y, 21M, 21C and a 21K, an intermediate transfer belt 22, and a belt cleaner 29. The process units 21Y, 21M, 21C and 21K are arranged in parallel along a moving direction of the intermediate transfer belt 22 to form toner images of yellow, magenta, cyan, and black, respectively. Note that Y, M, C, and K characters assigned to the end of the reference numerals in FIG. 1 may be omitted when the matters common to the four colors are described. The intermediate transfer belt 22 is stretched over a plurality of rollers and rotates. As will be described later, the toner images of the four color components are transferred to the intermediate transfer belt 22 and superimposed on each other (primary transfer), thereby forming a full-color toner image. The intermediate transfer belt 22 carries the full-color toner image and conveys it to a secondary transfer position T2.

The cassette 5 is an accommodation unit that accommodates a bundle of sheets. Although FIG. 1 shows an embodiment in which the image forming apparatus 100 includes only one cassette 5, the image forming apparatus 100 may include a plurality of cassettes 5 capable of accommodating sheets S of different types (e.g. size, thickness, or presence or absence of surface-coating). In this case, the sheet S of the type designated in each job is fed from the corresponding cassette 5. Note that the sheet S may be fed from a manual feed tray 6 instead of the cassette 5. Further, the image forming system 1 may include a paper feeder (not illustrated) separate from the image forming apparatus 100.

The conveyance unit 10 is a conveyance unit including a conveyance path and a plurality of rollers. The feeding roller 11 feeds the sheets one by one from the bundle of the sheets S in the cassette 5 to the conveyance path 12. The conveyance roller 13 conveys the sheet along the conveyance path 12. The registration roller 14 feeds the sheet S to the secondary transfer position T2 in synchronization with the timing at which the toner image on the intermediate transfer belt 22 reaches the secondary transfer position T2.

Since the configuration of the process units 21Y, 21M, 21C and 21K may be similar to each other, they are referred to as a process unit 21. The process unit 21 includes a photosensitive drum 23, a charger 24, an exposure unit 25, a developing unit 26, a primary transfer roller 27, and a drum cleaner 28. The photosensitive drum 23 is a cylindrical image carrier and rotates in the counterclockwise direction in the drawing. The charger 24 may be, for example, a corona charger that irradiates charged particles by corona discharge, and charges the surface of the photosensitive drum 23 to a uniform potential (e.g. a negative dark portion potential). The charger 24 may have a roller or a wire for discharging. The exposure unit 25 includes, for example, a semiconductor laser as a light source, and scans the surface of the photosensitive drum 23 with a laser beam according to the input image data to form an electrostatic latent image on the surface of the photosensitive drum 23. The developing unit 26 accommodates, for example, a developer including a toner and a carrier in its interior, and develops the electrostatic latent image on the surface of the photosensitive drum 23 by supplying the developer to the photosensitive drum 23 to form a toner image.

As an example, the developer may be a two-component developer including a non-magnetic toner and a magnetic carrier. The toner may contain a binder resin, a colorant, and a release agent (wax).

A primary transfer roller 27 is disposed at a primary transfer position T1 so as to face the photosensitive drum 23. The primary transfer roller 27 is supplied with a primary transfer bias of high voltage and transfers the toner image (here, yellow) on the surface of the photosensitive drum 23 to the intermediate transfer belt 22. The drum cleaner 28 removes a toner remaining on the surface of the photosensitive drum 23 after the primary transfer.

Similar to the process unit 21Y, magenta, cyan, and black toner images are formed in the process units 21M, 21C and 21K, respectively. Then, these toner images are sequentially transferred and superimposed on the yellow toner image on the intermediate transfer belt 22.

A secondary transfer outer roller 16 is disposed at the secondary transfer position T2 so as to face a secondary transfer inner roller 15, which is one of the rollers over which the intermediate transfer belt 22 is stretched. The secondary transfer outer roller 16 is supplied with a secondary transfer bias of high voltage and transfers the full-color toner image carried by the intermediate transfer belt 22 to the sheet S that has reached the secondary transfer position T2 (secondary transfer). The belt cleaner 29 removes a toner remaining on the intermediate transfer belt 22 after the secondary transfer.

The fixing unit 30 is a fixing unit disposed downstream of the secondary transfer position T2. The fixing unit 30 includes a fixing roller (or a cylindrical heating film) and a pressure roller, and fixes the toner image on the sheet S by heating and pressing the sheet S on which the toner image has been transferred. The sheet S that has passed through the fixing unit 30 is discharged to the outside of the image forming apparatus 100 (e.g. to a discharge tray (not illustrated).

When double-sided printing is executed, the sheet S on which the toner image is formed on the first surface is conveyed to the conveyance path 17. Therefore, the sheet S reverses the traveling direction and enters the conveyance path 18 for the double-sided printing. The sheet S returns to the conveyance path 12 with its front and back sides reversed. The toner image is transferred to the second surface of the sheet S at the secondary transfer position T2. The fixing unit 30 fixes the toner image on the second surface of the sheet S by heating and pressing the sheet S again. Then, the sheet S is discharged to the outside of the image forming apparatus 100.

The operation unit 40 is an operation unit that provides a user interface to a user of the image forming system 1. The operation unit 40 includes, for example, a touch panel 41. The touch panel 41 displays an image and information according to control by a main control unit 101 described later, and accepts a touch input by a user. The operation unit 40 may include an output device (e.g. a liquid crystal display or a speaker) and an input device (e.g. a button, a switch, a keypad, or a microphone) instead of (or in addition to) the touch panel 41.

The main control unit 101 is a control unit that controls the overall operation of the image forming apparatus 100. For example, the main control unit 101 controls the image forming unit 20 to form an image on the sheet S based on input image data received from an external device when the execution of the print job is instructed. The external device here may be, for example, a personal computer (PC) or an external controller. Although not shown in FIG. 1, the image forming apparatus 100 may further include a document reading unit. That is, the image forming apparatus 100 may be a multifunction peripheral. In this example, when the execution of the copy job is instructed, the main control unit 101 controls the image forming unit 20 to form an image on the sheet S based on the read image data generated by the scanner unit reading the document.

### 1-2. Foil Printer (Foil Processing Equipment)

The foil printer 120 includes a conveyance roller 111, a discharge roller 112, a heating roller 121, a pressure roller 122, a supply reel 131, a retrieval reel 132, and an upper discharge tray 140.

The conveyance roller 111 receives the sheet S on which the toner image is formed, and feeds the sheet S to an adhering position T3. In the adhering position T3, the heating roller 121 and the pressure roller 122 are disposed so as to face each other. The supply reel 131 is wound with a foil sheet 150 composed of foil and a film-shaped holding member for holding the foil. The leading end of the foil sheet 150 is fixed to the retrieval reel 132. The supply reel 131 and the retrieval reel 132 suspend the foil sheet 150 via the lower surface of the heating roller 121 while maintaining a predetermined tension so as not to cause wrinkles in the foil sheet 150. Although not shown in FIG. 1, the foil printer 120 may include additional suspension rollers to stably maintain the tension of the foil sheet 150.

The supply reel 131 rotates in the clockwise direction in the drawing to supply the foil sheet 150 to the adhering position T3. The heating roller 121 heats the sheet S that has reached the adhering position T3. Accordingly, at least one type of toner used as a glue (adhesive) among the toners constituting the toner image melts. The pressure roller 122, together with the heating roller 121, presses the foil sheet 150 against the sheet S. As a result, the melted toner acts as a glue, and the foil on the foil sheet 150 is adhered onto the sheet S via the toner. The retrieval reel 132 rotates in the counterclockwise direction in the drawing, and winds up the foil sheet 150. At this time, the foil on the foil sheet 150 is peeled off from the support member and adhered onto the sheet S to form an image of the foil on the sheet S. The discharge roller 112 discharges the sheet S that has passed through the adhering position T3 to the upper discharge tray 140.

### 1-3. Foil

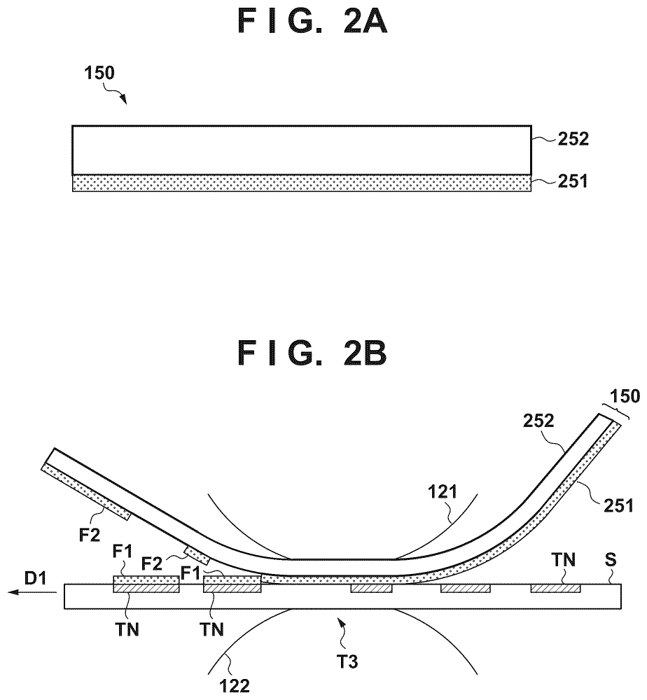

FIG. 2A shows an example of the construction of the foil sheet 150. The foil sheet 150 includes a foil layer 251 and a backup layer 252. The foil layer 251 is a sheet-like layer made of a metal material. The metal material of the foil layer 251 may be, for example, aluminum, tin, silver, copper, chromium, nickel, gold, or iron, or an alloy of two or more thereof (e.g. nickel-chromium steel, bronze, or aluminum bronze). The backup layer 252 is a sheet-like layer made of resin that supports the foil layer 251. The resin material of the backup layer 252 may be, for example, polyethylene terephthalate (PET), polyethylene naphthalate (PEN), polypropylene (PP), polyether sulfone (PES), or polyimide (PI).

### 1-4. Formation of Foil Images

FIG. 2B shows an enlarged view of the vicinity of the adhering position T3 while the foil printer 120 is operating. In this example, the heating roller 121 positioned on the adhering position T3 and the pressure roller 122 positioned below the adhering position T3 nip the sheet S on which the toner image TN is formed and the foil sheet 150. The heating roller 121 and the pressure roller 122 rotate according to the rotation of the retrieval reel 132 driven by a motor (not illustrated), and convey the sheet S and the foil sheet 150 toward the conveyance direction D1.

The surface temperature of the heating roller 121 is controlled so that the temperature of the toner in the toner image TN reaches the melting point. This temperature is, for example, from 140° C. to 180° C. When the temperature of the toner reaches the melting point at the adhering position T3, the toner melted and increased in viscosity acts as a glue. The toner image TN is further pressed by the pressure roller 122 to adhere onto the foil layer 251 of the foil sheet 150. Therefore, when the sheet S and the foil sheet 150 pass through the adhering position T3, the foil F1 of the foil layer 251 in contact with the toner image TN is peeled off from the backup layer 252 while being adhered onto the sheet S. On the other hand, the foil F2 of the foil layer 251 that is not in contact with the toner image TN is retrieved by the retrieval reel 132 while remaining on the backup layer 252 without being adhered onto the sheet S. Consequently, the foil layer 251 is selectively transferred to the sheet S according to the pattern of the toner image TN on the sheet S to form a foil image on the sheet S.

### 1-5. Post-Processing Equipment

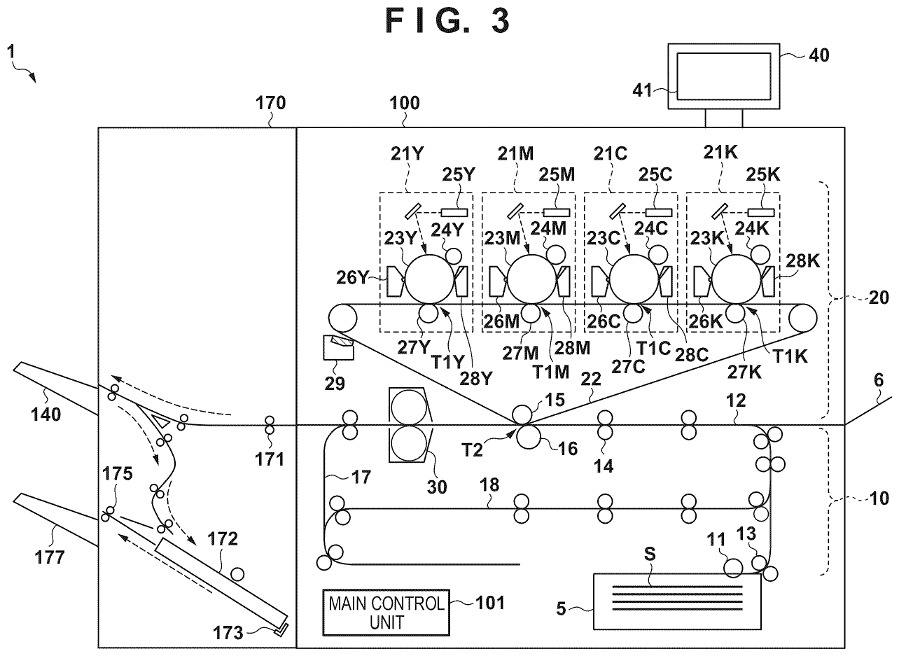

FIG. 3 shows an image forming system 1 including a post-processing apparatus 170. The image forming apparatus 100 forms a toner image (glue image) for adhering the foil onto the sheet S, and discharges the sheet S to the post-processing apparatus 170. The post-processing apparatus 170 conveys the sheet S by a plurality of conveyance rollers 171. When the sheet S is not subjected to post-processing, the sheet S is discharged to the upper discharge tray 140. When the sheet S is subjected to the post-processing, the sheet S is conveyed along a dashed arrow and is conveyed to the post-processing unit 172. The post-processing unit 172 executes the post-processing (sorting, grouping, stapling, bookbinding, and folding) of the type designated by the main control unit 101. When the post-processing is completed, the discharge plate 173 is moved in the arrow direction, whereby the post-processed sheet S(s) are discharged to the lower discharge tray 177.

Thus, there are a plurality of types of post-processing. Among the plurality of types of post-processing, there are types of post-processing that hinder foil printing (foil processing) in the foil printer 120. Therefore, in the present embodiment, by releasing or invalidating the post-processing designated by the print job or the post-processing designated by the operation unit 40, a defect in foil printing is suppressed, and wasteful consumption of consumables is reduced. Note that, there are a case in which post-processing is set in a print job transmitted from PC and a case in which post-processing is set in the operation unit 40 of the image forming apparatus 100. These two cases are described below.

### 1.6 Controller (Control System)

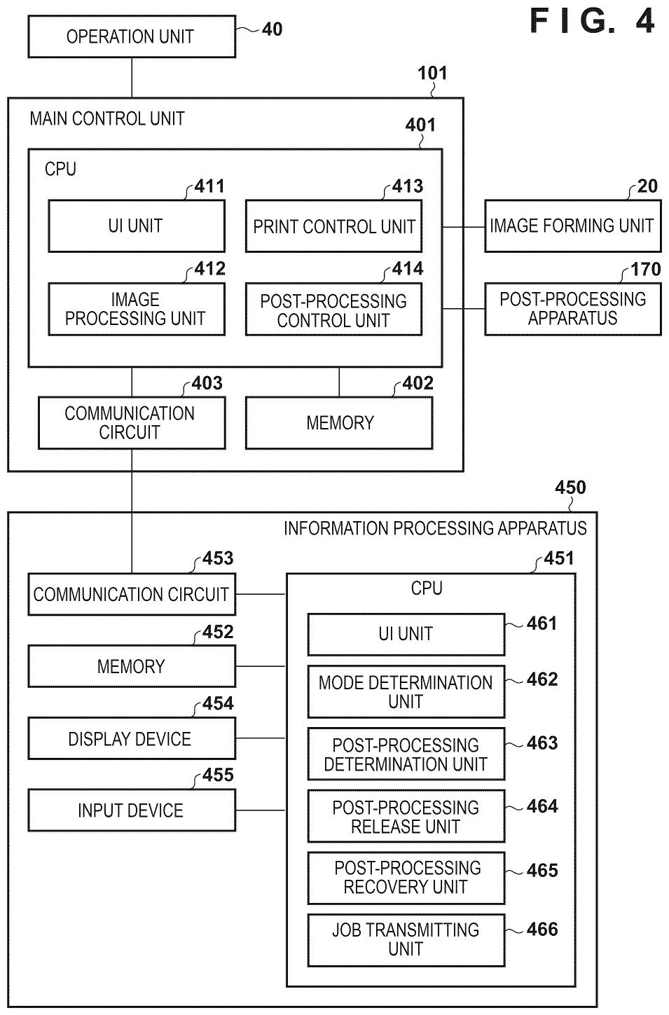

FIG. 4 shows a controller of the image forming system 1. A motor and a power supply other than the load illustrated are connected to the main control unit 101, since they are not a main idea of the present invention, their illustration and description are omitted.

The main control unit 101 includes, for example, a central processing unit (CPU) 401, a memory 402, and a communication circuit 403. The memory 402 may include a read only memory (ROM), a random access memory (RAM), and the like. The CPU 401 implements various functions by executing a control program stored in a ROM area of the memory 402.

A UI unit 411 displays information on the operation unit 40 and accepts an instruction and information inputted by a user through the operation unit 40. An image processing unit 412 expands print data described by a page description language (PDL) into image data, converts a color space of the image data, and so on. Further, the image processing unit 412 may enlarge or reduce an image or rotate an image.

The print control unit 413 controls the image forming unit 20 in accordance with a print job received from the information processing apparatus 450 via the communication circuit 403 to form a toner image on the sheet S. The post-processing control unit 414 controls the post-processing apparatus 170 to execute post-processing designated by the print job or post-processing set in advance through the operation unit 40.

These functions may be implemented individually by an integrated circuit provided outside the CPU 401 and can communicate with the CPU 401. The communication circuit 403 is an interface circuit used by the CPU 401 to communicate with the foil printer 120 and the information processing apparatus 450.

The image forming apparatus 100 may optionally communicate with the information processing apparatus 450. A CPU 451 of the information processing apparatus 450 executes an operating system (OS) and printer drivers stored in a memory 452 and controls the image forming apparatus 100. The CPU 451 communicates with the image forming apparatus 100 through communication circuit 453. The memory 452 is a storage device that may include a hard disk drive, a solid state drive (SSD), or the like in addition to ROM, and RAM. The display device 454 is a liquid crystal display or the like that displays a user interface (UI) or the like of the printer driver. An input device 455 may include a keyboard, a pointing device, a touch sensor, a microphone, and the like.

The CPU 451 includes a UI unit 461, a mode determination unit 462, a post-processing determination unit 463, a post-processing release unit 464, a post-processing recovery unit 465, and a job transmitting unit 466. The mode determination unit 462 determines which of a foil print mode in which a toner image (glue image) for foil printing is formed on the sheet S and a normal print mode in which a normal toner image that is not for foil printing is formed is designated by the user. The UI unit 461 displays a setting screen on the display device 454. The setting of the mode may be performed in advance through the setting screen. The post-processing determination unit 463 determines whether a predetermined post-processing has been selected by the user through a setting screen displayed on the display device 454 by the UI unit 461. The predetermined post-processing is a post-processing that causes a defect in foil printing. The post-processing release unit 464 temporarily releases the post-processing in the post-processing apparatus 170 when the foil print mode is selected and the predetermined post-processing is selected. The post-processing recovery unit 465 is an option, and re-activates (recovers) the post-processing after being temporarily released. The job transmitting unit 466 creates a print job and transmits the print job to the image forming apparatus 100 through the communication circuit 453. The print job is control data that may include information about a print mode, information about post-processing, image data, and the like.

### 1-7. Control Method

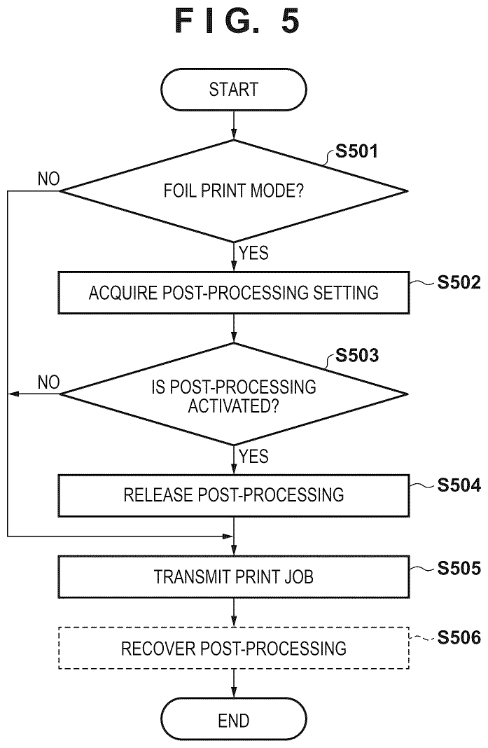

FIG. 5 shows control methods executed by the CPU 451 of the information processing apparatus 450. The CPU 451 executes the following process by executing the printer driver program.

In the step S501, the CPU 451 (mode determination unit 462) determines whether the print mode selected by the user is the foil print mode. If the selected print mode is not the foil print mode, post-processing such as stapling can be performed. Therefore, the CPU 451 proceeds from the step S501 to the step S505. If the selected print mode is a foil print mode, the CPU 451 proceeds from the step S501 to the step S502 because post-processing such as stapling is deprecated.

In the step S502, the CPU 451 (post-processing determination unit 463) acquires the post-processing setting selected by the user. The post-processing setting may be read from the memory 452 or may be acquired from the image forming apparatus 100 through the communication circuit 453. This is because, in the image forming apparatus 100, it may be selected to apply a predetermined post-processing by default or auto-setting.

In the step S503, the CPU 451 (post-processing determination unit 463) determines whether the post-processing is valid in the post-processing setting. It should be noted that it may be determined whether the type of post-processing that is activated results in a defect in foil processing. If the predetermined post-processing (e.g. stapling process) is activated, the CPU 451 advances the processing from the step S503 to the step S504. On the other hand, if the predetermined post-processing (e.g. stapling process) is not activated, the CPU 451 advances the processing from the step S503 to the step S505.

In the step S504, the CPU 451 (post-processing release unit 464) releases the predetermined post-processing in the print job. Thus, even when the user erroneously activates the predetermined post-processing in the foil print mode, the predetermined post-processing is invalidated, and wasteful consumption of the consumables is suppressed.

In the step S505, the CPU 451 (job transmitting unit 466) creates a print job and transmits the print job to the image forming apparatus 100. For example, a print job in the normal print mode or a print job in which a predetermined post-processing is cancelled or prohibited in the foil print mode is transmitted to the image forming apparatus 100.

In the step S506, the CPU 451 (post-processing) recovers to the post-processing after being released. For example, the CPU 451 sends an instruction to the image forming apparatus 100 to recover (activate) the post-processing temporarily canceled (disabled). This recovery process is optional and may be omitted.

As described above, in the first embodiment, the predetermined post-processing is canceled in a case where the user erroneously activates the predetermined post-processing in the foil print mode. As a result, the sheet S subjected to the post-processing is less likely to be inserted to the foil printer 120, and wasteful consumption of consumables will be reduced.

When the foil print mode is selected, the user may forget the setting change procedure of invalidating the predetermined post-processing. Even if such an artificial error occurs, it is difficult to cause a defect in foil printing.

In the present embodiment, the predetermined post-processing is canceled because the foil print mode is selected. In this case, the predetermined post-processing may be automatically re-activated. This will ensure that the post-processing expected by the user in the normal print mode is performed.

Although stapling process is exemplified as the predetermined post-processing, this is merely an example. The predetermined post-processing may include bending (e.g. double-folding, Z-folding), bookbinding, and the like. As a result, the foil print mode and the normal print mode can coexist without deteriorating the operability of the user.

### II. Second Embodiment

In the first embodiment, the predetermined post-processing is released in the information processing apparatus 450, but the predetermined post-processing may be released in the image forming apparatus 100. Therefore, in the second embodiment, the latter will be described in detail.

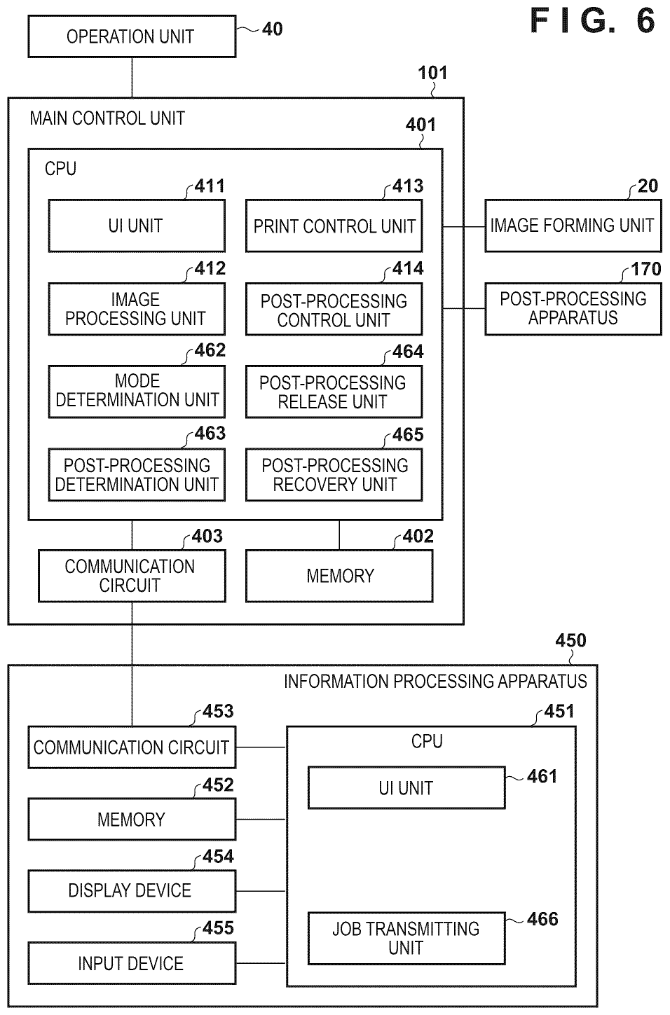

FIG. 6 shows a controller of the image forming system 1. The mode determination unit 462, the post-processing determination unit 463, the post-processing release unit 464, and the post-processing recovery unit 465 are implemented by the CPU 401 of the image forming apparatus 100. The job transmitting unit 466 of the information processing apparatus 450 transmits the print job including the print mode and the content of the post-processing to the image forming apparatus 100.

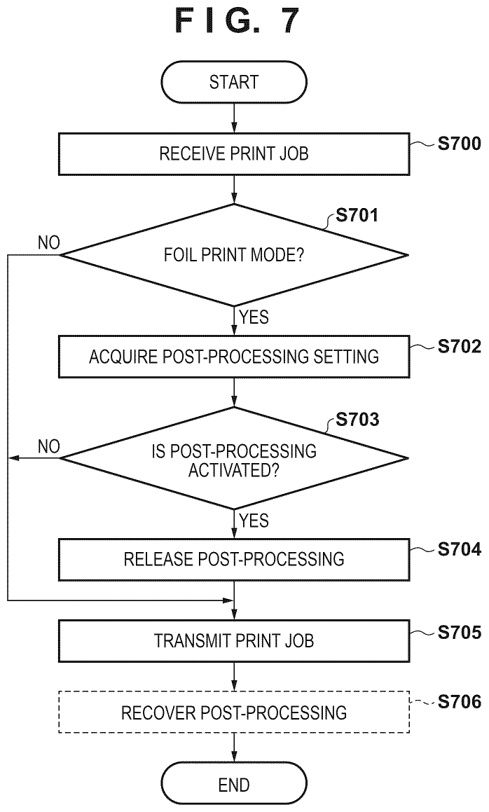

FIG. 7 shows a control method executed by the CPU 401 according to a control program.

In the step S700, the CPU 401 receives a print job from the information processing apparatus 450 via the communication circuit 403.

In the step S701, the CPU 401 (mode determination unit 462) analyzes the print job and determines whether the print mode is the foil print mode. If the print mode is the foil print mode, the CPU 401 advances the process from the step S701 to the step S702. If the print mode is the normal print mode, the CPU 401 advances the process from the step S701 to the step S705.

In the step S702, the CPU 401 (post-processing determination unit 463) acquires the post-processing setting from the print job or the memory 402.

In the step S703, the CPU 401 (post-processing determination unit 463) determines whether the predetermined post-processing is valid based on the acquired post-processing setting. If the predetermined post-processing is valid, the CPU 401 advances the process from the step S703 to the step S704. If the predetermined post-processing is invalid, the CPU 401 advances the process from the step S703 to the step S705.

In the step S704, the CPU 401 (post-processing release unit 464) releases the predetermined post-processing. Thus, the post-processing control unit 414 controls the post-processing apparatus 170 to discharge the sheet S to the upper discharge tray 140. That is, since the sheet S is not conveyed to the post-processing unit 172, the post-processing unit 172 does not execute the post-processing.

In the step S705, the CPU 401 (print control unit 413) executes a print job. If the foil print mode is designated in the print job, the print control unit 413 controls the image forming unit 20 to form a glue image on the sheet S in accordance with the print job. Thus, the post-processing control unit 414 controls the post-processing apparatus 170 to discharge the sheet S to the upper discharge tray 140. If the normal print mode is designated in the print job, the print control unit 413 controls the image forming unit 20 to form a toner image (normal image) on the sheet S in accordance with the print job. The post-processing control unit 414 conveys the sheet S to the post-processing unit 172, executes post-processing, and controls the post-processing apparatus 170 so as to be discharged to the lower discharge tray 177.

In the step S706, the CPU 401 (post-processing recovery unit 465) recovers (activates) the post-processing.

As described above, in the second embodiment, even if the foil print mode and the predetermined post-processing are designated in the print job, the image forming apparatus 100 can temporarily release the predetermined post-processing and execute the foil print mode. In the second embodiment, when the post-processing is activated through the operation unit 40 in the image forming apparatus 100 and the foil print mode is designated in the print job, the image forming apparatus 100 can temporarily release the post-processing and execute the foil print mode. The predetermined post-processing is released in a case where the user erroneously activates the predetermined post-processing in the foil print mode. As a result, the sheet S subjected to the post-processing is less likely to be inserted to the foil printer 120, and wasteful consumption of consumables will be reduced.

### III. Third Embodiment

In the first embodiment and the second embodiment, the setting of the foil print mode and the setting of the predetermined post-processing are independent, and it is assumed that the user can set the execution of the foil print mode and the execution of the predetermined post-processing. However, this is only an example. For example, if the foil print mode is selected by the user, a UI may be provided in which the predetermined post-processing cannot be selected.

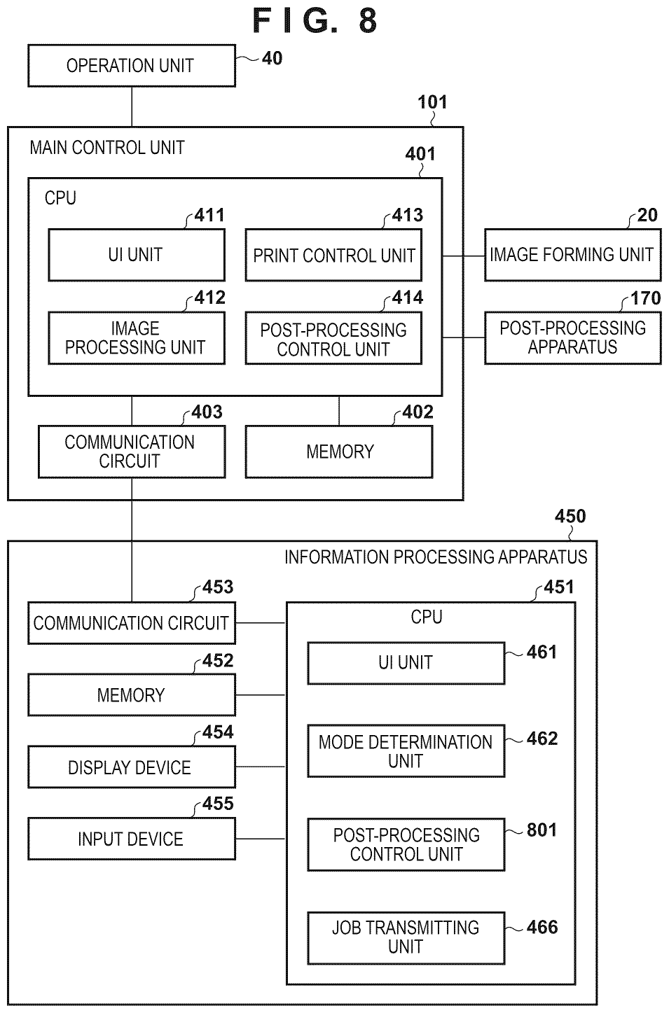

FIG. 8 shows a controller of the image forming system 1. Here, the CPU 451 includes a post-processing restriction unit 801 in addition to the UI unit 461, the mode determination unit 462, and the job transmitting unit 466 described above. When the mode determination unit 462 detects the selection of the foil print mode, the post-processing restriction unit 801 restricts or prohibits the selection of the predetermined post-processing in a UI displayed on the display device 454 by the UI unit 461.

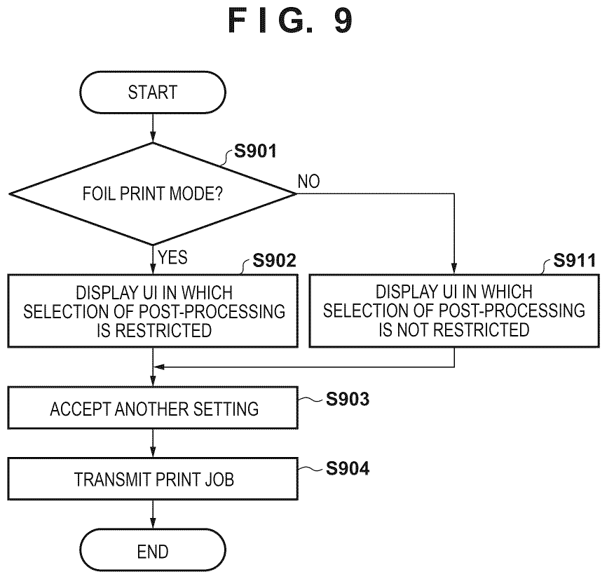

FIG. 9 shows a control method executed by the CPU 451 of the information processing apparatus 450.

In the step S901, the CPU 451 (mode determination unit 462) determines whether the foil print mode is selected as the foil print mode. If the foil print mode is selected, the CPU 451 advances the process from the step S901 to the step S902.

In the step S902, the CPU 451 (post-processing restriction unit 801, UI unit 461) displays, on the display device 454, a UI in which the selection of the post-processing is restricted.

In the step S903, the CPU 451 (UI unit 461) accepts another setting (e.g. single-sided printing, double-sided printing, or number of printed sheets).

In the step S904, the CPU 451 (job transmitting unit 466) transmits a print job to the image forming apparatus 100. Here, when the print mode is the foil print mode, in principle, a predetermined post-processing cannot be selected. Therefore, when the print mode is the foil print mode, a print job to which the predetermined post-processing is not applied is created.

In the step S901, the normal print mode may be selected. Therefore, the CPU 451 proceeds from the step S901 to the step S905.

In the step S911, the CPU 451 (post-processing restriction unit 801, UI unit 461) displays, on the display device 454, a UI in which the selection of the post-processing is not restricted. That is, the user can select a predetermined post-processing through the UI. After that, the CPU 451 executes the step S903 and the step S904.

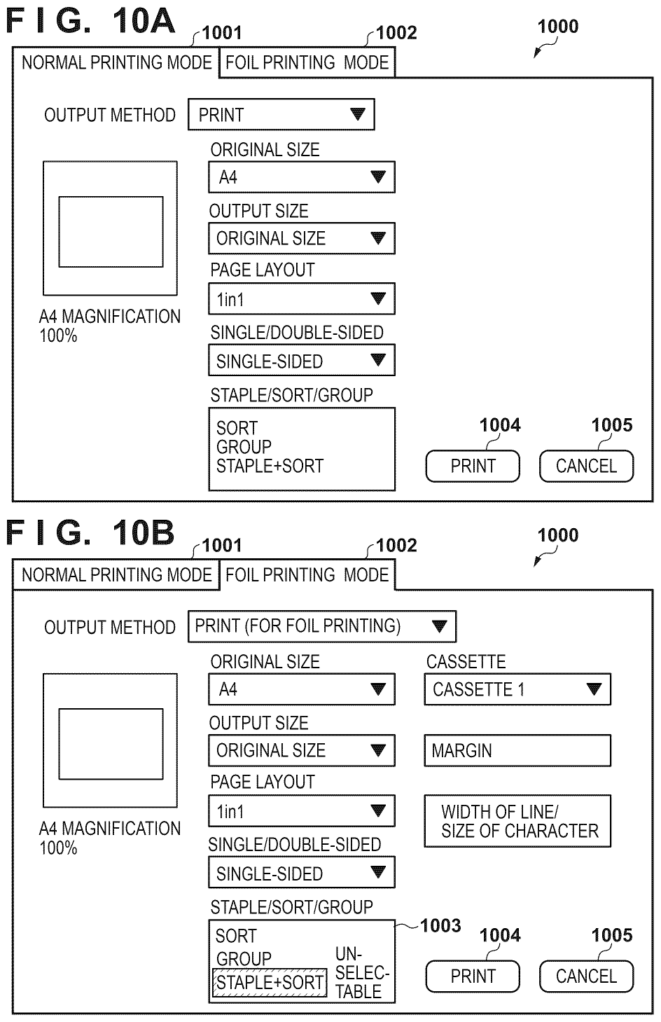

FIG. 10A illustrates a UI 1000 of the printer driver. The UI 1000 has a tab 1001 for the normal print mode and a tab 1002 for the foil print mode.

In FIG. 10A, the tab 1001 is selected by the user through the input device 455. The post-processing selection unit 1003 displays a list including a plurality of types of post-processing, and allows the user to select any type of post-processing. Here, the selection of the predetermined post-processing is not restricted by the post-processing restriction unit 801. The print button 1004 is a button for instructing the image forming apparatus 100 to execute printing. The cancel button 1005 is a button for canceling the setting.

FIG. 10B illustrates the tab 1002 for the foil print mode. In the foil print mode, the selection of the predetermined post-processing should be restricted. Therefore, the post-processing restriction unit 801 and the UI unit 461 gray-out the predetermined post-processing (e.g. stapling+sorting) in the post-processing selection unit 1003. This makes it impossible to select the predetermined post-processing. Note that the post-processing restriction unit 801 may delete the predetermined post-processing from a plurality of listed options. As a result, the predetermined post-processing is not displayed on the post-processing selection unit 1003, so that the user cannot select the predetermined post-processing. Note that the post-processing restriction unit 801 displays the predetermined post-processing on the post-processing selection unit 1003, but may ignore the selection of the predetermined post-processing by the user.

In this way, in the present embodiment, selection of the predetermined post-processing is prohibited in the foil print mode. Therefore, a defect in foil processing is less likely to occur, and wasteful consumption of consumables will be suppressed.

### IV. Fourth Embodiment

In the fourth embodiment, a case in which the selection of the foil print mode and the selection of the post-processing can be executed in the image forming apparatus 100 will be described. Therefore, the restriction of the selection of the predetermined post-processing is also executed in the image forming apparatus 100.

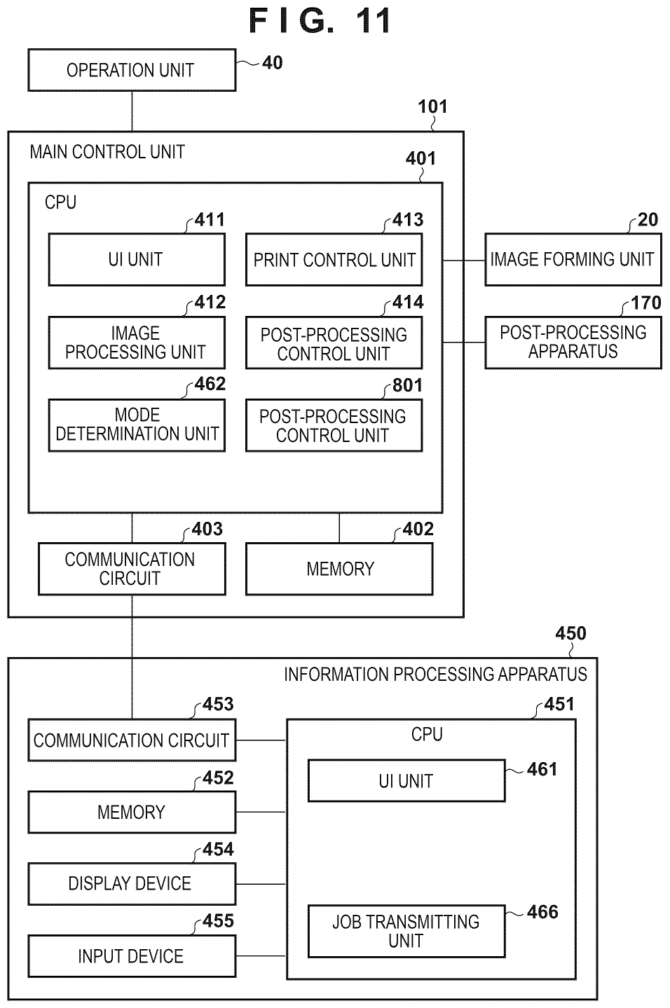

FIG. 11 shows a controller of the image forming system 1. The mode determination unit 462 and the post-processing restriction unit 801 are implemented by the CPU 401. The mode determination unit 462 analyzes the print job to determine whether or not the foil print mode is set to the print mode. Alternatively, the mode determination unit 462 determines whether or not the foil print mode is set to the print mode based on an instruction input through the operation unit 40. When the foil print mode is selected, the post-processing restriction unit 801 restricts selection of a predetermined post-processing in a UI displayed on the operation unit 40.

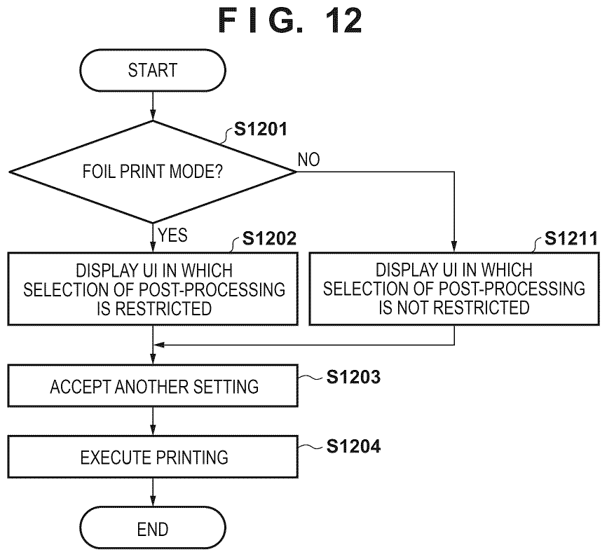

FIG. 12 shows a control method executed by the CPU 401 of the image forming apparatus 100.

In the step S1201, the CPU 401 (mode determination unit 462) determines whether the foil print mode is selected as the print mode. If the foil print mode is selected, the CPU 401 advances the process from the step S1201 to the step S1202.

In the step S1202, the CPU 401 (post-processing restriction unit 801, UI unit 411) displays, on the operation unit 40, a UI in which the selection of the post-processing is restricted.

In the step S1203, the CPU 401 (UI unit 411) accepts another setting (e.g. single-sided printing, double-sided printing, or number of printed sheets).

In the step S1204, the CPU 401 (print control unit 413 and post-processing control unit 414) executes printing in accordance with a print job. Here, when the print mode is the foil print mode, in principle, the predetermined post-processing cannot be selected. Therefore, when the print mode is the foil print mode, the predetermined post-processing is not applied.

In the step S1201, the normal print mode may be selected. In this case, the CPU 401 proceeds from the step S1201 to the step S1211.

In the step S1211, the CPU 401 (post-processing restriction unit 801, UI unit 411) displays, on the operation unit 40, a UI in which the selection of the post-processing is not restricted. That is, the user can select the predetermined post-processing through the UI. After that, the CPU 401 executes the step S1203 and the step S1204.

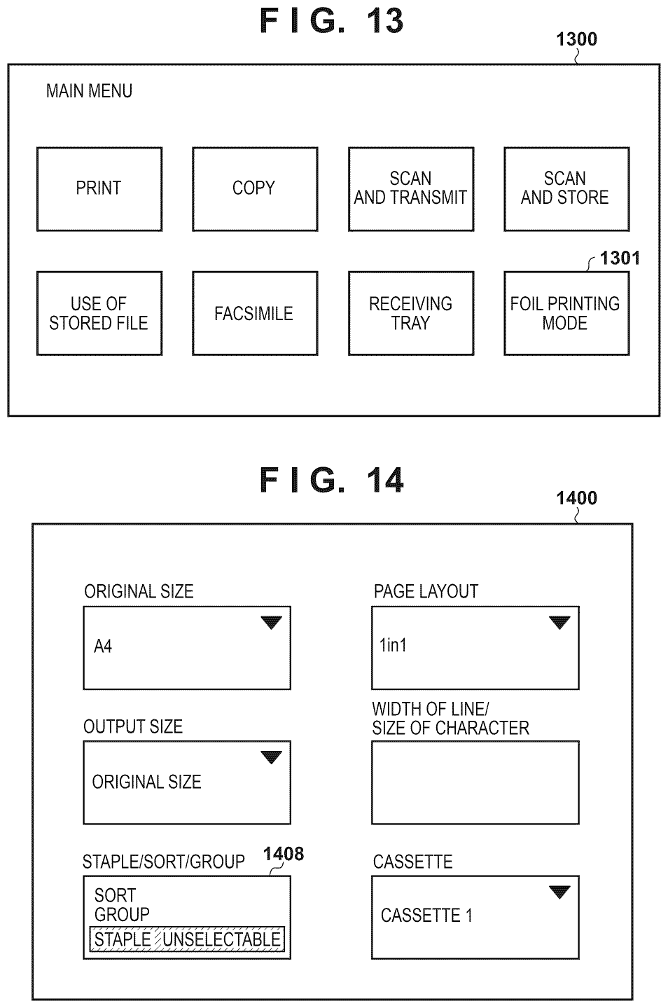

FIG. 13 illustrates a setting UI 1300 displayed on the operation unit 40. The setting UI 1300 includes a button 1301 for selecting a foil print mode.

FIG. 14 illustrates a setting UI 1400 of the foil print mode that is displayed on the operation unit 40 when the button 1301 is pressed. The post-processing selection unit 1408 displays a list including a plurality of types of post-processing, and allows the user to select any type of post-processing. Here, the selection of the predetermined post-processing is restricted by the post-processing restriction unit 801. Note that, when the normal print mode is selected, the post-processing restriction unit 801 displays, on the operation unit 40, the setting UI 1400 that does not restrict the selection of the predetermined post-processing.

In FIG. 14, the selection of the predetermined post-processing is restricted by the gray-out. However, this is only an example. The post-processing restriction unit 801 may delete the predetermined post-processing from a plurality of listed options. Accordingly, since the predetermined post-processing is not displayed on the post-processing selection unit 1003, the user cannot select the predetermined post-processing. The post-processing restriction unit 801 displays the predetermined post-processing on the post-processing selection unit 1003, but may ignore the selection of the predetermined post-processing by the user.

In this way, in the present embodiment, selection of the predetermined post-processing is prohibited in the foil print mode. Therefore, a defect in foil processing is less likely to occur, and wasteful consumption of consumables will be suppressed.

### V. Supplement

The image forming unit 20 is an example of an image forming unit that is provided in the image forming apparatus 100 and forms a toner image on the sheet S as an adhesive. The CPUs 401, 451 may function as control units for controlling the image forming unit and the post-processing apparatus 170. The CPUs 401, 451, the operation unit 40, and the input device 455 function as selection units that select a first mode for forming a toner image for adhering foil onto a sheet via a toner image. The CPUs 401, 451, the operation unit 40, and the input device 455 function as accepting units that accepts data related to post-processing. When the first mode is selected, the CPUs 401, 451, the operation unit 40, and the display device 454 function as display units that display a warning in accordance with information related to post-processing. This reduces the likelihood of a defect occurring when forming the foil.

The CPUs 401, 451 restrict application of predetermined post-processing (e.g. stapling, bookbinding, and folding) by the post-processing apparatus 170 to the sheet S on which the toner image is formed as an adhesive. This suppresses wasteful consumption of consumables when forming a foil image in an image forming system capable of performing post-processing. The predetermined post-processing subjected to the warning includes a post-processing that inhibits adhesion of the foil to the sheet S by the foil printer 120. The predetermined post-processing includes, for example, stapling process, bookbinding, or folding.

The foil print mode is an example of a first mode of forming a toner image used as an adhesive for adhering the foil onto the sheet S. The normal print mode is an example of a second mode of forming a toner image that is not used as an adhesive for the foil. The CPUs 401, 451 may restrict the application of the predetermined post-processing by the post-processing apparatus 170 to the sheet S when the first mode is selected, and may allow the application of the predetermined post-processing by the post-processing apparatus 170 to the sheet S when the second mode is selected.

As described in the third and fourth embodiments, the CPUs 401, 451 may restrict the application of the predetermined post-processing by the post-processing apparatus 170 to the sheet S by restricting the selection of the predetermined post-processing by an operator.

The CPU 401 is provided in the image forming apparatus 100. The CPU 451 is provided in the information processing apparatus 100.

As described in the first and second embodiments, the CPUs 401, 451 may disable (release) the application of the predetermined post-processing when the forming of the toner image as the adhesive on the sheet S and the application of the predetermined post-processing are selected. This suppresses a defect in foil printing and wasteful consumption of consumables due to human error.

The CPU 401 may activate (recover) the application of the predetermined post-processing when the forming of the toner image as the adhesive on the sheet S is completed. In this way, the recovery operation of the predetermined post-processing by the user can be reduced.

When the first mode is selected, the CPUs 401, 451 may function as control units that control the accepting unit such that the accepting unit can select the first post-processing as the post-processing and cannot select the second post-processing different from the first post-processing.

The operation unit 40 and the display device 454 function as display units that display a plurality of post-processes as options. The operation unit 40 and the display device 454 may display the second post-processing so that the second post-processing cannot be selected, delete the predetermined post-processing from the second post-processing, or ignore the selection of the second post-processing from the plurality of displayed post-processing.

When the first mode is selected, the CPUs 401, 451 may not release the selection of the first post-processing as the post-processing selected by the accepting unit and release the selection of the second post-processing different from the first post-processing.

The job transmitting unit 466 and the communication circuit 453 function as transmitting units that transmit a job for forming a toner image on the sheet S to the image forming apparatus 100 as an adhesive for adhering the foil onto the sheet S in the foil printer 120. The CPU 451 functions as a control unit that controls the image forming apparatus 100 through the transmitting unit. The CPU 451 may restrict the application of a predetermined post-processing to the sheet S on which the toner image is formed as an adhesive by the image forming apparatus 100. Note that, when the application of the predetermined post-processing is restricted, the CPU 451 may display the warning information on the operation unit 40 or the display device 454 of the information processing apparatus 450. The warning information includes, for example, a character or an image indicating that a predetermined post-processing is restricted in the foil print mode.

When the forming of the toner image as the adhesive on the sheet S and the application of the predetermined post-processing are selected, the CPU 451 disables the application of the predetermined post-processing.

The CPU 451 may restrict the application of the predetermined post-processing to the sheet S by restricting the operator's selection of the predetermined post-processing.

The image forming unit 20 is an example of an image forming unit that forms a toner image used in the foil printer 120 on the sheet S as an adhesive for adhering the foil onto the sheet S. The main control unit 101 and the CPU 401 are examples of a control unit that controls the image forming unit 20. The CPU 401 may restrict the application of the predetermined post-processing to the sheet S on which the toner image is formed as the adhesive by the image forming unit 20. Note that, when the application of the predetermined post-processing is restricted, the CPU 401 may display the warning information on the operation unit 40 or the display device 454 of the information processing apparatus 450. The warning information includes, for example, a character or an image indicating that the predetermined post-processing is restricted in the foil print mode.

When the forming of the toner image as the adhesive on the sheet S and the application of the predetermined post-processing are selected, the CPU 401 disables the application of the predetermined post-processing.

The CPU 401 may restrict the application of the predetermined post-processing to the sheet S by restricting the operator's selection of the predetermined post-processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-060398, filed Apr. 3, 2024 which is hereby incorporated by reference herein in its entirety.

What is claimed is:

1. An image forming apparatus comprising:
an input unit configured to accept a selection of a first mode for forming a toner image for adhering foil onto a sheet via the toner image and an input of information relating to post-processing;
an image forming unit configured to form the toner image on the sheet; and
a display unit configured to display a warning according to the information relating to the post-processing, when the first mode is selected by the input unit.

2. The image forming apparatus according to claim 1, wherein
the post-processing subject to the warning includes post-processing that inhibits adhesion of the foil to the sheet by a foil printing apparatus.

3. The image forming apparatus according to claim 2, wherein
the post-processing subjected to the warning includes stapling, bookbinding, or folding.

4. The image forming apparatus according to claim 1, wherein
the input unit is further configured to accepts a selection of one of the first mode and a second mode for forming a toner image that is not used as an adhesive of the foil, and
the image forming apparatus is further configured to:
restrict application of the post-processing subjected to the warning by the post-processing apparatus to the sheet, when the first mode is selected, and allow application of the post-processing by the post-processing apparatus to the sheet, when the second mode is selected.

5. The image forming apparatus according to claim 4, further comprising
a control unit configured to restrict application of post-processing subjected to the warning by the post-processing apparatus to the sheet by restricting selection of the post-processing subject to the warning by an operator.

6. The image forming apparatus according to claim 1, further comprising
a control unit configured to disables application of the post-processing subjected to the warning, when formation of the toner image as an adhesive on the sheet and the application of the post-processing subjected to the warning are selected.

7. The image forming apparatus according to claim 6, wherein
the control unit is further configured to activate application of the post-processing subjected to the warning upon completion of the formation of the toner image as the adhesive on the sheet.

8. An image forming apparatus comprising:
an input unit configured to accept a selection of a first mode for forming a toner image for adhering foil onto a sheet via the toner image and an input of information relating to post-processing;
an image forming unit configured to form the toner image on the sheet; and
a control unit configured to control the input unit such that first post-processing as post-processing can be selected by the input unit when the first mode is selected by the input unit, and a second post-processing different from the first post-processing cannot be selected.

9. The image forming apparatus according to claim 8, further comprising
a display unit configured to display a plurality of post-processing as an option,
wherein the control unit is further configured to:
display the second post-processing so that the second post-processing cannot be selected,
delete the second post-processing from the plurality of post-processing, or
ignore a selection of the second post-processing from the plurality of post-processing displayed on the display unit, thereby the selection of the second post-processing by an operator is restricted.

10. An image forming apparatus comprising:
an input unit configured to accept a selection of a first mode for forming a toner image for adhering foil onto a sheet via the toner image and an input of information relating to post-processing;
an image forming unit configured to form the toner image on the sheet; and
a control unit configured to release a selection of a second post-processing different from the first post-processing, and not to release the selection of the first post-processing as the post-processing selected by the input unit, when the first mode is selected by the input unit.

11. The image forming apparatus according claim 1, further comprising
a foil printing unit configured to adhere foil onto a sheet via a toner image formed on the sheet by the image forming unit.

12. The image forming apparatus according claim 8, further comprising a foil printing unit configured to adheres a foil to a sheet via a toner image formed on the sheet by the image forming unit.

13. The image forming apparatus according to claim 10, further comprising:
a foil printing unit configured to adheres a foil to a sheet via a toner image formed on the sheet by the image forming unit.

14. An information processing apparatus comprising:
an input unit configured to accept a selection of a first mode for forming a toner image for adhering foil onto a sheet via the toner image and an input of information relating to post-processing; and
a display unit configured to display a warning according to information relating to the post-processing, when the first mode is selected by the input unit.

15. An information processing apparatus comprising:
an input unit configured to accept a selection of a first mode for forming a toner image for adhering foil onto a sheet via the toner image and an input of information relating to post-processing; and
a control unit configured to control the input unit such that a first post-processing as post-processing can be selected by the input unit, and a second post-processing different from the first post-processing cannot be selected, when the first mode is selected by the input unit.

16. An information processing apparatus comprising:
an input unit configured to accept a selection of a first mode for forming a toner image for adhering foil onto a sheet via the toner image and an input of information relating to post-processing; and
a control unit configured to release a selection of a second post-processing different from first post-processing, and not to release the selection of the first post-processing as the post-processing selected by the input unit, when the first mode is selected by the input unit.
